(19) United States
(12) Patent Application Publication
(10) Pub. No.: US 2026/0021983 A1
(43) Pub. Date: Jan. 22, 2026

(54) MEDIUM FEEDING APPARATUS

(71) Applicant: PFU LIMITED, Kahoku-shi (JP)

(72) Inventor: Takayuki Umi, Kahoku-shi (JP)

(21) Appl. No.: 19/259,360

(22) Filed: Jul. 3, 2025

(30) Foreign Application Priority Data
Jul. 18, 2024 (JP) 2024-114869

(51) Int. Cl. B65H 3/06; B65H 7/02; H04N 1/12

(52) U.S. Cl. CPC B65H 3/0669; B65H 3/0661; B65H 3/0676; B65H 7/02; B65H 2301/4232; B65H 2403/80; B65H 2403/92; B65H 2553/80; B65H 2801/39; H04N 1/1215

(57) ABSTRACT

A medium feeding apparatus includes a media tray, a feed roller to feed a medium placed on the media tray, a driving source to generate a driving force, and a drive transmission assembly to transmit the driving force from the driving source to a rotation shaft of the feed roller. The drive transmission assembly is located inner than an end of a medium conveying path in a direction intersecting a medium conveying direction.

### CROSS-REFERENCE TO RELATED APPLICATIONS

This patent application is based on and claims priority pursuant to 35 U.S.C. § 119(a) to Japanese Patent Application No. 2024-114869, filed on Jul. 18, 2024, in the Japan Patent Office, the entire disclosure of which is hereby incorporated by reference herein.

### BACKGROUND

The present disclosure relates to a medium feeding apparatus.

Medium feeding apparatuses such as a scanner or a printer perform a process such as an imaging process or an image forming process on a medium while feeding the medium by a feed roller.

A medium feeding apparatus in the related art includes a lower unit that forms a lower portion of the housing thereof, and an upper unit that opens and closes with respect to the lower unit. In this medium feeding apparatus, a first driving source for driving at least a feed roller and a second driving source for driving at least a conveyance roller are located on opposite sides with respect to the center of the lower unit in the width direction intersecting the medium conveying direction.

### SUMMARY

The medium feeding apparatus according to one aspect of the present disclosure includes a media tray, a feed roller to feed a medium placed on the media tray, a driving source to generate a driving force, and a drive transmission assembly to transmit the driving force from the driving source to a rotation shaft of the feed roller. The drive transmission assembly is located inner than an end of a medium conveying path in a direction intersecting a medium conveying direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a medium feeding apparatus according to an embodiment;

FIG. 2 is a diagram illustrating a conveying path inside the medium feeding apparatus illustrated in FIG. 1;

FIGS. 3A and 3B are schematic diagrams for explaining a set guide, etc.;

FIG. 4 is a schematic diagram for explaining a medium conveying path;

FIG. 5 is a schematic diagram for explaining the medium conveying path illustrated in FIG. 4;

FIG. 6 is a schematic diagram for explaining a drive mechanism;

FIG. 7 is a schematic diagram for explaining a first motor drive transmission assembly;

FIG. 8 is a schematic diagram for explaining the first motor drive transmission assembly illustrated in FIG. 7;

FIG. 9 is a schematic diagram for explaining a second motor drive transmission assembly;

FIG. 10 is a schematic diagram for explaining a first sensor, etc.;

FIG. 11 is a schematic diagram for explaining the first sensor, etc., illustrated in FIG. 10;

FIG. 12 is a block diagram illustrating a schematic configuration of a medium feeding apparatus;

FIG. 13 is a block diagram illustrating schematic configurations of a memory and a processing circuit;

FIG. 14 is a flowchart of a medium reading process;

FIG. 15 is a schematic diagram for explaining a first sensor, etc., according to another embodiment; and

FIG. 16 is a block diagram illustrating a schematic configuration of another processing circuit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, medium feeding apparatuses according to embodiments of the present disclosure are described below. As used herein, the singular forms “a,” “an,” and “the” are intended to include the plural forms as well, unless the context clearly indicates otherwise. The technical scope of the present disclosure is not limited to the embodiments described below and covers equivalents of elements described below.

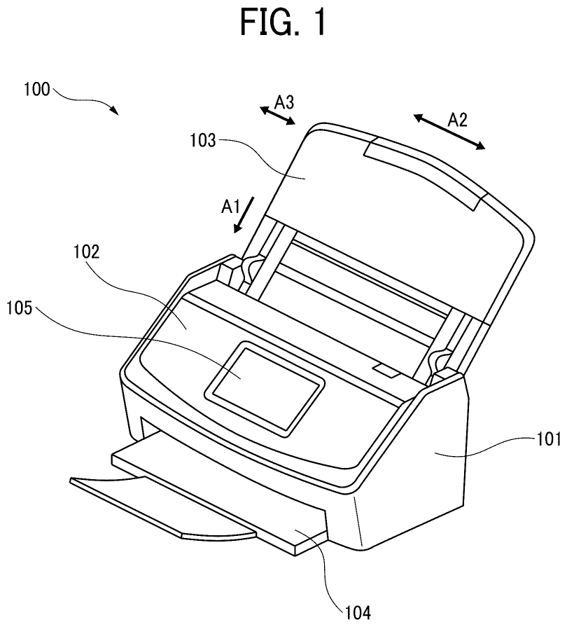

FIG. 1 is a perspective view of a medium feeding apparatus 100 as an image scanner.

The medium feeding apparatus 100 conveys, images, and ejects a medium that is a document. Examples of the media include paper, thick paper, cards, booklets, and passports. The medium feeding apparatus 100 may be a facsimile machine, a copier, or a multifunction peripheral (MFP).

In FIG. 1, arrow A1 indicates the direction in which a medium is conveyed (also “a medium conveying direction A1”), arrow A2 indicates the width direction perpendicular to the medium conveying direction A1, and arrow A3 indicates the height direction perpendicular to a medium conveying path. In the following description, upstream is upstream in the medium conveying direction A1, and downstream is downstream in the medium conveying direction A1. The width direction A2 is an example of a direction intersecting the medium conveying direction A1.

The medium feeding apparatus 100 includes a lower housing 101, an upper housing 102, a media tray 103, an ejection tray 104, and a display and operation device 105.

The upper housing 102 is located to cover the upper side of the medium feeding apparatus 100 and hinged to the lower housing 101 such that the upper housing 102 is opened and closed, for example, to remove a jammed medium or clean the inside of the medium feeding apparatus 100.

The media tray 103 is hinged to the lower housing 101 and is rotatable. When the medium feeding apparatus 100 is not used, the media tray 103 is located to cover the lower housing 101 and the upper housing 102 and functions as an exterior cover. When the medium feeding apparatus 100 is used, the media tray 103 is located at such a position that media to be fed and conveyed can be placed thereon. The ejection tray 104 is engaged with the lower housing 101, and the ejected media are stacked thereon. The ejection tray 104 may be engaged with the upper housing 102 with a hinge or the like.

The display and operation device 105 includes a display and an interface circuit that outputs image data to the display, and displays the image data on the display. Examples of the display include a liquid crystal display and an organic electro-luminescence (EL) display. The display and operation device 105 further includes a touch-screen input device and an interface circuit that receives signals from the input device. The display and operation device 105 receives an input operation performed by a user and outputs an operation signal corresponding to the input operation performed by the user. The medium feeding apparatus 100 may include a display device and an operation device separately.

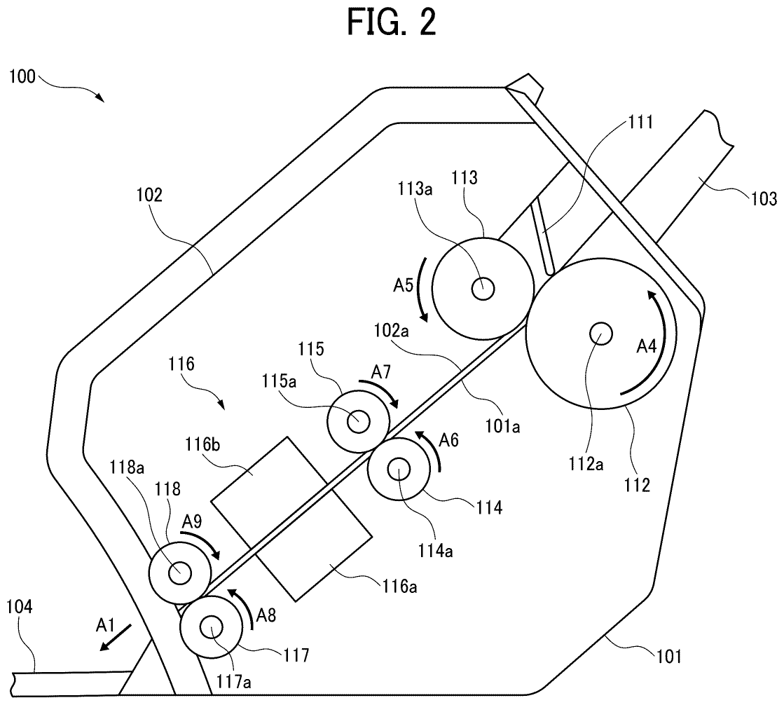

FIG. 2 is a diagram illustrating a conveying path inside the medium feeding apparatus 100.

The medium feeding apparatus 100 includes a media sensor 111, a feed roller 112, a separation roller 113, a first conveyance roller 114, a second conveyance roller 115, an imaging device 116 including an image sensor, a first ejection roller 117, and a second ejection roller 118 along the medium conveying path.

The number of each of the feed roller 112, the separation roller 113, the first conveyance roller 114, the second conveyance roller 115, the first ejection roller 117, and/or the second ejection roller 118 is not limited to one but may be two or more. When the feed roller 112, the separation roller 113, the first conveyance roller 114, the second conveyance roller 115, the first ejection roller 117, and/or the second ejection roller 118 are formed of multiple rollers, the multiple rollers are located at intervals in the width direction A2. The first conveyance roller 114, the second conveyance roller 115, the first ejection roller 117, or the second ejection roller 118 is an example of a conveyance roller.

The upper surface of the lower housing 101 forms a lower guide 101a of the medium conveying path, and the lower surface of the upper housing 102 forms an upper guide 102a of the medium conveying path. As illustrated in FIG. 2, the medium conveying path is a so-called straight path, and the vertical relative positions of the front side and the back side of a medium do not change between when the medium is fed from the media tray 103 and when the medium is ejected onto the ejection tray 104.

The media sensor 111 is located upstream from the feed roller 112 and the separation roller 113. The media sensor 111 includes a contact sensor and detects whether a medium is placed on the media tray 103. The media sensor 111 generates a media signal having a value that changes depending on whether a medium is placed on the media tray 103 and outputs the generated media signal. The media sensor 111 is not limited to a contact sensor but may be any sensor, such as an optical sensor, to detect the presence of a medium.

The feed roller 112 is in the lower housing 101, separates the media on the media tray 103 one by one from the bottom, and sequentially feeds the media. The separation roller 113 is a so-called brake roller or retard roller, located in the upper housing 102, and faces the feed roller 112. The separation roller 113 separates a medium from the media on the media tray 103. The feed roller 112 and the separation roller 113 are rotatable about a feed shaft 112a and a separation shaft 113a, which are rotation shafts, respectively. The separation roller 113 is rotatable in the direction indicated by arrow A5 opposite to the rotation direction for feeding a medium (i.e., the medium feeding direction). Alternatively, the separation roller 113 is stoppable. Instead of the separation roller 113, a separation pad may be used.

The first conveyance roller 114 and the second conveyance roller 115 are examples of the conveyance roller. The first conveyance roller 114 and the second conveyance roller 115 are located downstream from the feed roller 112 and the separation roller 113 in the medium conveying direction A1 and face each other. The first conveyance roller 114 and the second conveyance roller 115 are rotatable about a first conveyance shaft 114a and a second conveyance shaft 115a, which are rotation shafts, respectively. The first conveyance roller 114 and the second conveyance roller 115 convey the medium fed by the feed roller 112 and the separation roller 113 to the imaging device 116.

The imaging device 116 images the medium conveyed by the first conveyance roller 114 and the second conveyance roller 115. The imaging device 116 includes a first imaging device 116a and a second imaging device 116b facing each other across the medium conveying path.

The first imaging device 116a includes an imaging sensor that is a unity-magnification contact image sensor (CIS). The CIS includes complementary metal oxide semiconductor (CMOS) imaging elements aligned linearly in the main scanning direction. The first imaging device 116a further includes a lens that forms an image on the imaging elements and an analog-to-digital (A/D) converter. The A/D converter amplifies the electrical signals output from the imaging elements and performs analog-to-digital (A/D) conversion. The first imaging device 116a images the front side of the medium being conveyed, generates input images sequentially, and outputs the input images.

Similarly, the second imaging device 116b includes an imaging sensor that is a unity-magnification CIS including CMOS imaging elements aligned linearly in the main scanning direction. The second imaging device 116b further includes a lens that forms an image on the imaging elements and an A/D converter. The A/D converter amplifies the electrical signals output from the imaging elements and performs A/D conversion. The second imaging device 116b images the back side of the medium being conveyed, generates an input image, and outputs the input image.

Alternatively, the medium feeding apparatus 100 may include either the first imaging device 116a or the second imaging device 116b to read only one side of the medium. The imaging sensor may be a line sensor that employs a unity-magnification CIS including charge-coupled device (CCD) imaging elements. Alternatively, the imaging sensor may be a reduction-optical line sensor including CMOS or CCD imaging elements.

The first ejection roller 117 and the second ejection roller 118 are examples of the conveyance roller. The first ejection roller 117 and the second ejection roller 118 facing each other are located downstream from the imaging device 116, that is, downstream from the feed roller 112 and the separation roller 113, in the medium conveying direction A1. The first ejection roller 117 and the second ejection roller 118 are rotatable about a first ejection shaft 117a and a second ejection shaft 118a, which are rotation shafts, respectively. The first ejection roller 117 and the second ejection roller 118 eject the medium that is conveyed by the first conveyance roller 114 and the second conveyance roller 115 and is processed (imaged) by the imaging device 116 to the ejection tray 104.

The media placed on the media tray 103 are conveyed between the lower guide 101a and the upper guide 102a in the medium conveying direction A1 as the feed roller 112 rotates in the direction indicated by arrow A4 in FIG. 2, which is the medium feeding direction. The medium feeding apparatus 100 has two operation modes: a separation mode in which one medium is separated and fed from the media on the media tray 103, and a non-separation mode in which media are fed without being separated. In the separation mode, the separation roller 113 rotates in the direction indicated by arrow A5 opposite to the medium feeding direction, or is kept stationary when a medium is conveyed. When two or more media are placed on the media tray 103, only the medium in contact with the feed roller 112 is separated from the rest of the media on the media tray 103 due to the action of the feed roller 112 and the separation roller 113. This operation prevents the feeding of a medium other than the separated medium (prevention of multi-feed). In the non-separation mode, the separation roller 113 rotates following the feed roller 112 in the medium feeding direction opposite to the direction indicated by arrow A5 when conveying a medium.

The medium is fed between the first conveyance roller 114 and the second conveyance roller 115 while being guided by the lower guide 101a and the upper guide 102a. The medium is fed between the first imaging device 116a and the second imaging device 116b as the first conveyance roller 114 and the second conveyance roller 115 rotate in the directions indicated by arrows A6 and A7 in FIG. 2, respectively. The medium read by the imaging device 116 is ejected onto the ejection tray 104 as the first ejection roller 117 and the second ejection roller 118 rotate in the directions indicated by arrows A8 and A9 in FIG. 2, respectively.

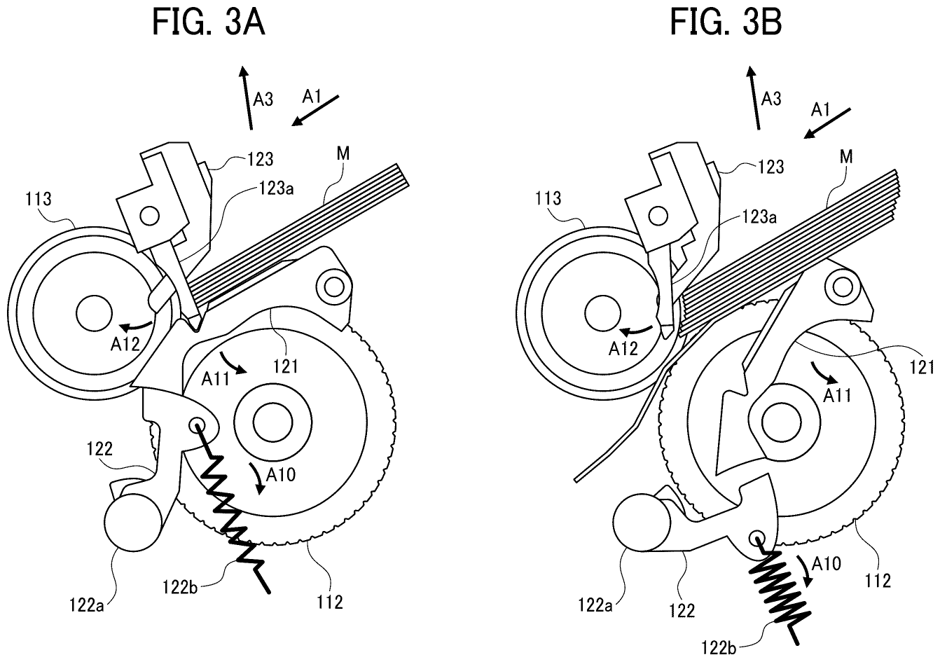

FIGS. 3A and 3B are schematic diagrams for explaining a set guide 121, a cam 122, and an arm 123. FIG. 3A is a schematic side view of the set guide 121, a cam 122, and an arm 123 before a medium is fed. FIG. 3B is a schematic side view of the set guide 121, the cam 122, and the arm 123 while a medium is fed.

As illustrated in FIGS. 3A and 3B, the medium feeding apparatus 100 includes the set guide 121, the cam 122, and the arm 123.

The set guide 121 is a guide for setting a bundle of media M on the media tray 103. As illustrated in FIG. 3A, the set guide 121 is rotatably (swingably) supported by the lower housing 101. Before the media M are fed, the set guide 121 is located at a position facing the feed roller 112 and the separation roller 113 in the medium conveying direction A1. When the feeding of the media M is not executed, the set guide 121 supports the lower side of the media M placed on the media tray 103 and restricts the contact between the media M on the media tray 103 and the feed roller 112. In the following description, the position at which the set guide 121 restricts the contact between the media M on the media tray 103 and the feed roller 112 as illustrated in FIG. 3A may be referred to as a restrictive position. The restrictive position is an example of a first position.

The cam 122 is an example of a moving mechanism to move the set guide 121. The cam 122 is located below the set guide 121. The cam 122 is rotatable (swingable) about a cam shaft 122a that is a rotation shaft. The cam 122 is supported by the lower housing 101 to be rotated by the driving force from a first motor to be described later. When a medium is not fed, the cam 122 contacts the downstream end of the set guide 121 to hold the set guide 121 at the restrictive position.

The cam 122 is provided with an elastic member 122b. The clastic member 122b is a spring, such as a tension coil spring or a torsion coil spring. One end of the elastic member 122b is attached to a frame fixed to the lower housing 101, and the other end of the elastic member 122b is attached to the cam 122. The elastic member 122b applies a downward force to the cam 122.

The arm 123 is a guide to press down the top medium of the bundle of media M on the media tray 103 or restrict the floating of the medium. The arm 123 is pressed downward toward the set guide 121 by, for example, a spring or a rubber member. The arm 123 includes a swingable flap 123a. The flap 123a is a stopper to prevent the medium M from entering the nip between the feed roller 112 and the separation roller 113 before the medium is fed. The flap 123a is located at a position facing the set guide 121 in the medium conveying direction A1. The flap 123a is an example of a restricting portion. The flap 123a is engaged with the set guide 121 positioned at the restrictive position and restricts contact between the leading end of the medium placed on the media tray 103 and the separation roller 113 before the medium is fed.

If the leading end of the medium contacts the separation roller 113 before the medium is fed, the medium is lifted by the separation roller 113 rotating in the direction opposite to the medium feeding direction, causing the medium to be jammed. With the flap 123a, the medium feeding apparatus 100 can prevent such a situation.

As illustrated in FIG. 3B, when the medium M is fed, the cam 122 swings (rotates) downward in the direction indicated by arrow A10 by the driving force from the first motor and separates from the downstream end of the set guide 121. When the downstream end of the set guide 121 separates from the cam 122 and is no longer held by the cam 122, the set guide 121 swings in the direction indicated by arrow A11 to a position below a media conveying plane and separates from the lower side of the medium M on the media tray 103. Accordingly, the medium placed on the media tray 103 is allowed to contact the feed roller 112. In the following description, the position illustrated in FIG. 3B at which the set guide 121 is separate from the lower side of the medium M on the media tray 103 and allows the contact between the medium M on the media tray 103 and the feed roller 112 may be referred to as a non-restrictive position. The non-restrictive position is an example of a second position. As described above, the set guide 121 is positioned at the restrictive position and the non-restrictive position, and the cam 122 moves the set guide 121 between the restrictive position and the non-restrictive position.

As described above, the clastic member 122b applies the downward force to the cam 122. Accordingly, the elastic member 122b applies a load to the cam 122 in a direction in which the set guide 121 moves from the restrictive position to the non-restrictive position.

When the set guide 121 is positioned at the non-restrictive position, the set guide 121 is released from the engagement with the flap 123a. Accordingly, the flap 123a is pushed by the leading end of the medium M on the media tray 103 and swings downstream in the direction indicated by arrow A12, and the medium M is allowed to enter the nip between the feed roller 112 and the separation roller 113. As described above, when the set guide 121 is positioned at the non-restrictive position, the flap 123a allows the medium M to enter the nip between the feed roller 112 and the separation roller 113.

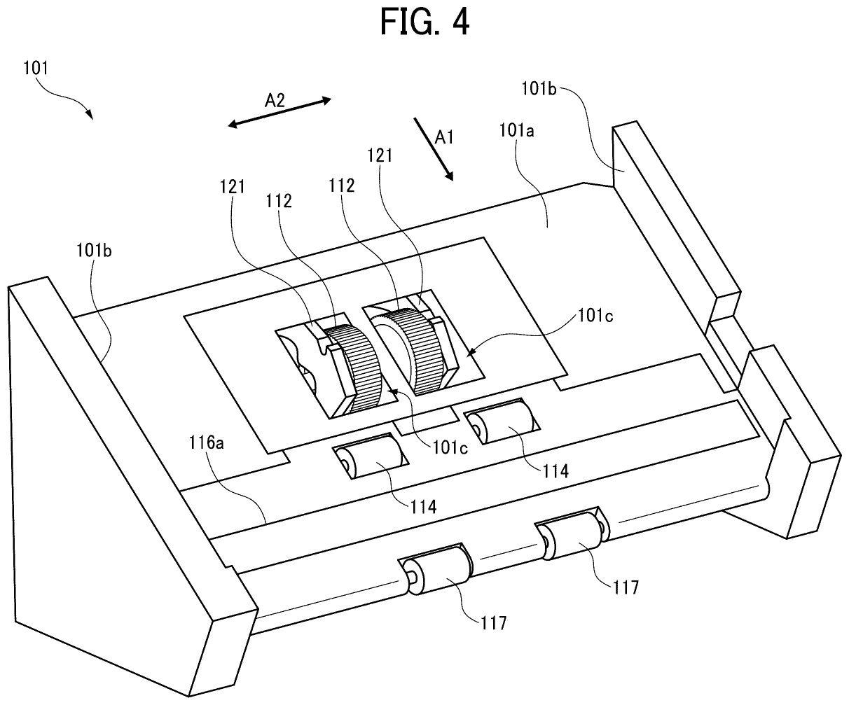

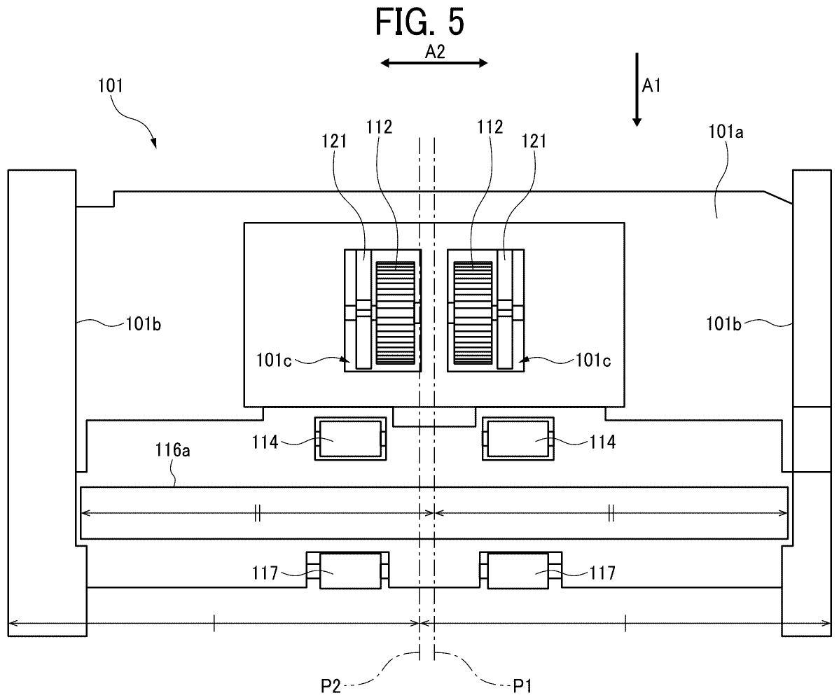

FIGS. 4 and 5 are schematic diagrams for explaining the medium conveying path in the medium feeding apparatus 100. FIG. 4 is a perspective view of the lower housing 101 from which the upper housing 102, the media tray 103, and the ejection tray 104 are detached, as viewed from downstream and from above. FIG. 5 is a schematic diagram of the lower housing 101 from which the upper housing 102, the media tray 103, and the ejection tray 104 are detached, viewed from above. In FIGS. 4 and 5, the medium feeding apparatus 100 includes two feed rollers 112 and two set guides 121, but the numbers thereof are not limited thereto. In the following description, the singular forms are used to simplify the description.

As illustrated in FIGS. 4 and 5, the lower guide 101a forms the medium conveying path. At each end of the lower guide 101a in the width direction A2, a sidewall 101b extending in the height direction A3 is located. In other words, the sidewall 101b is located at both ends of the medium conveying path in the width direction A2. The end of the medium in the width direction A2 contacts the sidewall 101b, and the medium is conveyed along the sidewall 101b. This prevents the occurrence of skew of the medium.

The feed roller 112 and the set guide 121 are located in a recessed portion 101c in the lower guide 101a as illustrated in FIGS. 4 and 5.

In the width direction A2, a center position P1 of the medium conveying path (the imaging range of the imaging device 116) does not match a center position P2 of the entire medium feeding apparatus 100 but is shifted to the right from the center position P2 as illustrated in FIG. 5.

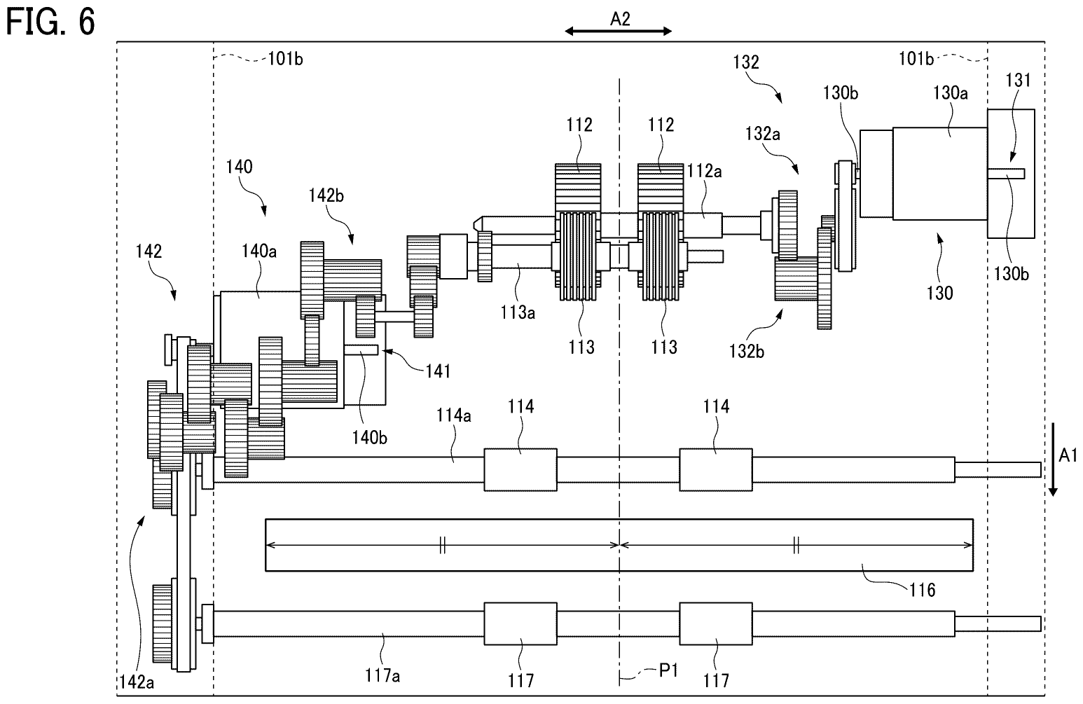

FIG. 6 is a schematic diagram for explaining the drive mechanism of the feed roller 112, the separation roller 113, the first conveyance roller 114, the second conveyance roller 115, the first ejection roller 117, the second ejection roller 118, and the cam 122. FIG. 6 is a perspective view of the drive mechanism as viewed from above.

As illustrated in FIG. 6, the medium feeding apparatus 100 further includes a first motor 130, a first sensor 131, a first motor drive transmission assembly 132, a second motor 140, a second sensor 141, and a second motor drive transmission assembly 142.

The first motor 130 is an example of a driving source. The first motor 130 generates a first driving force for rotating (swinging) the feed roller 112 and the cam 122 according to a control signal from a processing circuit described later. The first driving force is an example of a driving force. Examples of the first motor 130 include a direct current (DC) motor, in particular, a brushed DC motor. The first motor 130 is not limited to a DC motor but may be another motor, such as a stepper motor. The first motor 130 generates the first driving force for rotating the feed roller 112 in the medium feeding direction A4 and rotating (swinging) the cam 122 downward. One of the feed roller 112 and the cam 122 may be rotated by the driving force generated by the second motor 140 or a motor different from the first motor 130 and the second motor 140.

The first motor 130 includes a first body 130a and a first rotation shaft 130b. The first body 130a is an example of a body. The first body 130a includes windings, a stator, a permanent magnet, and a commutator. The first rotation shaft 130b is a rotor. The first rotation shaft 130b protrudes from the first body 130a toward the center position P1 and outward the medium conveying path in the width direction A2.

The first sensor 131 is an example of a sensor and detects the rotation amount of the first motor 130. The first sensor 131 is located on the portion of the first rotation shaft 130b of the first motor 130 that protrudes outward the medium conveying path. The first sensor 131 is located outside the medium conveying path in the width direction A2, that is, outside the sidewall 101b. The first sensor 131 may be located on the portion of the first rotation shaft 130b of the first motor 130 that protrudes toward the center position P1. Alternatively, the first sensor 131 may be located closer to the center position P1 than the end of the medium conveying path in the width direction A2.

The first motor drive transmission assembly 132 includes a feed roller drive transmission assembly 132a and a cam drive transmission assembly 132b. The feed roller drive transmission assembly 132a is an example of a drive transmission assembly. The feed roller drive transmission assembly 132a transmits the first driving force generated by the first motor 130 from the first motor 130 to the feed shaft 112a. The cam drive transmission assembly 132b transmits the first driving force generated by the first motor 130 from the first motor 130 to the cam shaft 122a.

The first motor drive transmission assembly 132 is connected to the portion of the first rotation shaft 130b of the first motor 130 that protrudes toward the center position P1. The first motor drive transmission assembly 132 is located closer to the center position P1 than the end of the medium conveying path in the width direction A2, that is, closer to the center position P1 than the sidewall 101b. The first motor drive transmission assembly 132 is located at a position overlapping the imaging device 116 when viewed in the medium conveying direction A1. Further, the first motor drive transmission assembly 132 is located closer to the feed roller 112 than the first body 130a of the first motor 130 in the width direction A2. This arrangement can reduce the size of the medium feeding apparatus 100 in the width direction A2. The first motor drive transmission assembly 132 may be connected to the portion of the first rotation shaft 130b of the first motor 130 that protrudes from the first body 130a outward the medium conveying path. The first motor drive transmission assembly 132 may be located outside the medium conveying path in the width direction A2.

The second motor 140 is an example of a second driving source. The second motor 140 is located on the opposite side of the first motor 130 with respect to the center position P1 of the medium conveying path in the width direction A2. By arranging the first motor 130 and the second motor 140 on different sides in the width direction A2, the weight of the medium feeding apparatus 100 can be equalized on both sides in the width direction A2.

The second motor 140 generates a second driving force for rotating the separation roller 113, the first conveyance roller 114, the second conveyance roller 115, the first ejection roller 117, and/or the second ejection roller 118 according to a control signal from the processing circuit. Examples of the second motor 140 include a DC motor, in particular, a brushed DC motor. The second motor 140 is not limited to a DC motor but may be another motor, such as a stepper motor. The second motor 140 generates a second driving force for rotating the separation roller 113 in the direction A5 (see FIG. 2) opposite to the medium feeding direction and for rotating the first conveyance roller 114, the second conveyance roller 115, the first ejection roller 117, and/or the second ejection roller 118 in the medium conveying directions A6 to A9 (see FIG. 2), respectively. The second conveyance roller 115 and the second ejection roller 118 may be driven rollers to be rotated by the first conveyance roller 114 and the first ejection roller 117, respectively. Alternatively, one or more of the separation roller 113, the first conveyance roller 114, the second conveyance roller 115, the first ejection roller 117, and the second ejection roller 118 may be rotated by the first motor 130 or a driving force generated by a motor different from both the first motor 130 and the second motor 140.

The second motor 140 includes a second body 140a and a second rotation shaft 140b. The second body 140a includes windings, a stator, a permanent magnet, and a commutator. The second rotation shaft 140b is a rotor. The second rotation shaft 140b protrudes from the second body 140a toward the center position P1 and outward the medium conveying path in the width direction A2.

The second sensor 141 detects the rotation amount of the second motor 140. The second sensor 141 is located on the portion of the second rotation shaft 140b of the second motor 140 that protrudes toward the center position P1. The second sensor 141 is located closer to the center position P1 than the end of the medium conveying path in the width direction A2, that is, closer to the center position P1 than the sidewall 101b. Further, the second sensor 141 is located closer to the feed roller 112 than the second body 140a of the second motor 140 in the width direction A2. This arrangement can reduce the size of the medium feeding apparatus 100 in the width direction A2. The second sensor 141 may be located on the portion of the second rotation shaft 140b of the second motor 140 that protrudes outward the medium conveying path. Alternatively, the second sensor 141 may be located outside the medium conveying path in the width direction A2.

The second motor drive transmission assembly 142 includes a conveyance roller drive transmission assembly 142a and a separation roller drive transmission assembly 142b. The conveyance roller drive transmission assembly 142a is an example of a second drive transmission assembly. The separation roller drive transmission assembly 142b is an example of a third drive transmission assembly. The conveyance roller drive transmission assembly 142a transmits the second driving force generated by the second motor 140 from the second motor 140 to the first conveyance shaft 114a, the second conveyance shaft 115a, the first ejection shaft 117a, and the second ejection shaft 118a. The separation roller drive transmission assembly 142b transmits the second driving force generated by the second motor 140 from the second motor 140 to the separation shaft 113a.

The second motor drive transmission assembly 142 may be connected to the portion of the second rotation shaft 140b of the second motor 140 that protrudes from the second body 140a outward the medium conveying path. In other words, the second motor drive transmission assembly 142 is connected to the side opposite the feed roller 112 across the second body 140a of the second motor 140 in the width direction A2. The second motor drive transmission assembly 142, which includes the conveyance roller drive transmission assembly 142a and the separation roller drive transmission assembly 142b, is located on the opposite side of the first motor drive transmission assembly 132 with respect to the center position P1 of the medium conveying path in the width direction A2. This arrangement can equalize the weight of the medium feeding apparatus 100 on both sides in the width direction A2.

The conveyance roller drive transmission assembly 142a is located outside the medium conveying path in the width direction A2, that is, outside the sidewall 101b. The conveyance roller drive transmission assembly 142a is located at a position not overlapping the imaging device 116 when viewed in the medium conveying direction A1. Further, the conveyance roller drive transmission assembly 142a is located outer than the second body 140a of the second motor 140 in the width direction A2. The separation roller drive transmission assembly 142b is located on the same side as the conveyance roller drive transmission assembly 142a with respect to the center position P1 of the medium conveying path in the width direction A2. The range in which the second motor drive transmission assembly 142 is located in the width direction A2 includes an arca outside the medium conveying path, that is, an area outside the sidewall 101b. This allows the second motor drive transmission assembly 142 to easily transmit the second driving force from the lower housing 101 to the upper housing 102 through the area outside the medium conveying path. As a result, the medium feeding apparatus 100 can drive the first conveyance roller 114, the second conveyance roller 115, the first ejection roller 117, and the second ejection roller 118 by a single motor, i.e., the second motor 140.

As illustrated in FIG. 5, the center position P2 of the entire medium feeding apparatus 100 is located closer to the second motor drive transmission assembly 142 than the center position P1 of the medium conveying path (the imaging range of the imaging device 116) in the width direction A2. Accordingly, the medium feeding apparatus 100 can reduce the space for the first motor drive transmission assembly 132 having a small number of components while allocating the space for the second motor drive transmission assembly 142 having a large number of components. Therefore, the first motor drive transmission assembly 132 and the second motor drive transmission assembly 142 can be efficiently arranged in the medium feeding apparatus 100, and the apparatus size in the width direction A2 can be reduced.

The second motor drive transmission assembly 142 may be connected to the portion of the second rotation shaft 140b of the second motor 140 that protrudes toward the center position P1. The second motor drive transmission assembly 142 may be located closer to the center position P1 than the end of the medium conveying path in the width direction A2.

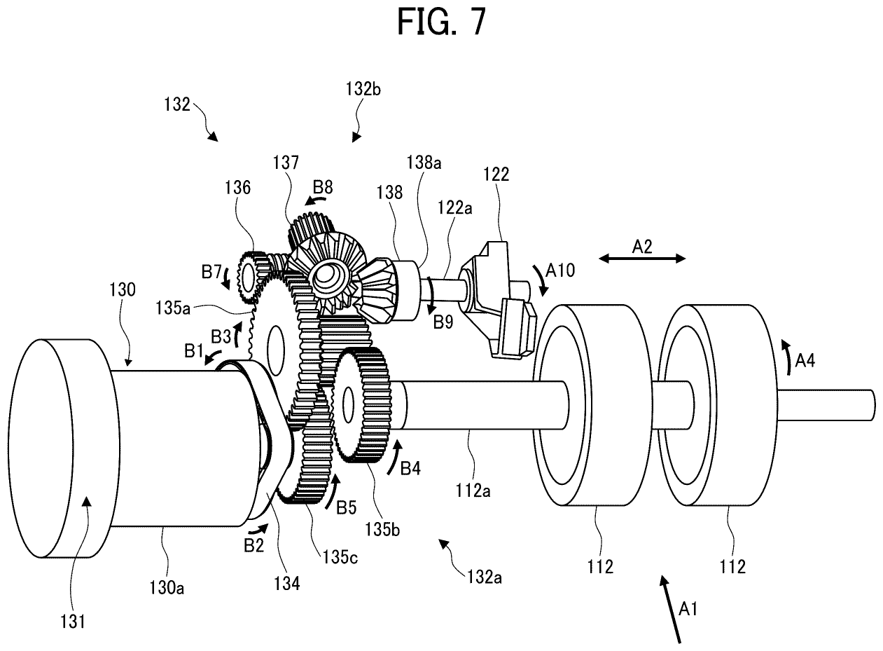

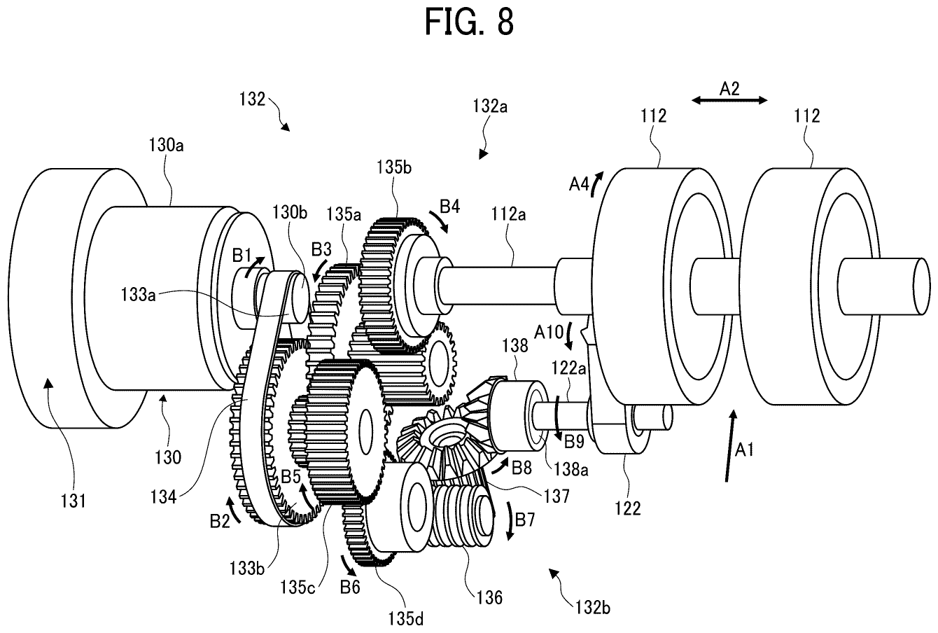

FIGS. 7 and 8 are schematic diagrams for explaining the first motor drive transmission assembly 132. FIG. 7 is a perspective view of the first motor drive transmission assembly 132 as viewed from upstream and from the left. FIG. 8 is a perspective view of the first motor drive transmission assembly 132 as viewed from upstream and from the right.

The feed roller drive transmission assembly 132a includes first and second pulleys 133a and 133b, a belt 134, and first and second gears 135a and 135b. The cam drive transmission assembly 132b includes the first and second pulleys 133a and 133b, the belt 134, the first gear 135a, third and fourth gears 135c and 135d, a worm 136, a worm wheel 137, and a bevel gear 138. In other words, the feed roller drive transmission assembly 132a and the cam drive transmission assembly 132b share the first and second pulleys 133a and 133b, the belt 134, and the first gear 135a.

The first pulley 133a is mounted on the portion of the first rotation shaft 130b of the first motor 130 that protrudes toward the center position P1. The belt 134 is stretched around the first pulley 133a and the second pulley 133b. The second pulley 133b includes a gear portion engaged with the first gear 135a. The first gear 135a is engaged with the second gear 135b. The second gear 135b is mounted on the feed shaft 112a on which the feed roller 112 is mounted.

The first gear 135a is further engaged with the third gear 135c. The third gear 135c is engaged with the fourth gear 135d. The worm 136 and the worm wheel 137 together form a worm gear having a so-called self-lock function. The worm 136 is a cylindrical worm, and a gear is formed on the side surface of the worm 136. One end of the worm 136 includes a gear portion engaged with the fourth gear 135d, and a screw-shaped gear portion is formed on the rest of the worm 136. The worm wheel 137 includes helical teeth that engage with the screw-shaped gear formed on the side surface of the worm 136. Accordingly, the worm wheel 137 rotates following the rotation of the worm 136. The lead angle of the groove of the worm 136 is set to prevent the transmission of rotation from the worm wheel 137 to the worm 136. Thus, the worm 136 is not rotated by the rotation of the worm wheel 137, and generates a load that restricts the transmission to the fourth gear 135d of the force transmitted from the worm wheel 137.

One end of the worm wheel 137 includes a bevel gear portion engaged with the bevel gear 138. The bevel gear 138 is mounted on the cam shaft 122a on which the cam 122 is mounted. The bevel gear 138 includes a one-way clutch 138a. When the bevel gear 138 is rotated in the direction in which the set guide 121 is moved from the non-restrictive position to the restrictive position by the first driving force from the first motor 130, the one-way clutch 138a transmits the rotational force of the bevel gear 138 to the cam shaft 122a. In contrast, when the bevel gear 138 is rotated in the direction in which the set guide 121 is moved from the restrictive position to the non-restrictive position by the first driving force from the first motor 130, the one-way clutch 138a idles the bevel gear 138 with respect to the cam shaft 122a.

In the following description, operations of the cam 122 and the feed roller 112 will be described.

When the first motor 130 generates a driving force to rotate in the direction indicated by arrow B1, the first and second pulleys 133a and 133b rotate in the directions indicated by arrows B1 and B2, respectively, and the first and second gears 135a and 135b rotate in the directions indicated by arrows B3 and B4, respectively. As a result, the feed roller 112 is rotated by the first driving force from the first motor 130 in the medium feeding direction A4, together with the feed shaft 112a. As described above, the feed roller drive transmission assembly 132a transmits the first driving force for rotating the feed roller 112 from the first motor 130 to the feed shaft 112a.

In addition, when the first gear 135a rotates in the direction indicated by arrow B3, the third and fourth gears 135c and 135d rotate in the directions indicated by arrows B5 and B6, respectively, and the worm 136 and the worm wheel 137 rotate in the directions indicated by arrows B7 and B8, respectively. With the rotation, the bevel gear 138 rotates in the direction indicated by arrow B9, but the one-way clutch 138a does not transmit the rotational force of the bevel gear 138 to the cam shaft 122a. However, the cam shaft 122a becomes rotatable in the direction indicated by arrow B9. By contrast, the downward force is applied to the cam 122 by the elastic member 122b. Thus, the cam 122 rotates in the direction indicated by arrow B9 (downward direction A10) together with the cam shaft 122a by the force from the elastic member 122b. Accordingly, the set guide 121 moves from the restrictive position to the non-restrictive position. The one-way clutch 138a may be omitted, and the cam 122 may be rotated in the direction indicated by arrow B9 (downward direction A10) by the first driving force from the first motor 130.

In contrast, when the first motor 130 generates the first driving force to rotate in the direction opposite to the direction indicated by arrow B1, the first and second pulleys 133a and 133b, the first to fourth gears 135a to 135d, the worm 136, the worm wheel 137, and the bevel gear 138 rotate in the directions opposite to the directions indicated by arrows B1 to B9, respectively. Accordingly, the cam 122 rotates in the upward direction, and the set guide 121 moves from the non-restrictive position to the restrictive position. In this manner, the cam drive transmission assembly 132b transmits the first driving force for moving the set guide 121 from the first motor 130 to the cam shaft 122a.

With the cam 122 moved in the upward direction and the set guide 121 positioned at the restrictive position, the downward force is applied to the cam 122 by the elastic member 122b. Accordingly, a rotational force in the direction indicated by arrow B9 is applied to the cam shaft 122a, and the rotational force of the cam shaft 122a is transmitted to the worm wheel 137 via the one-way clutch 138a and the bevel gear 138. However, as described above, the worm 136 is not rotated by the rotation of the worm wheel 137, and generates a load that restricts the transmission to the fourth gear 135d of the force transmitted from the worm wheel 137. Accordingly, even when the supply of power to the first motor 130 is stopped with the set guide 121 positioned at the restrictive position, the set guide 121 is kept at the restrictive position.

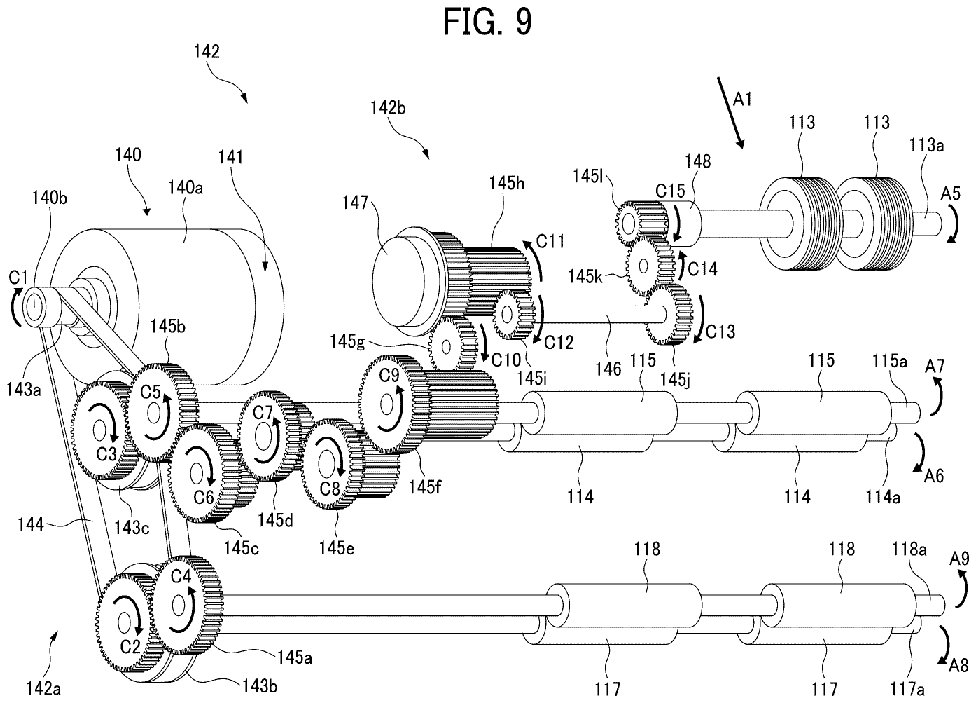

FIG. 9 is a schematic diagram for explaining the second motor drive transmission assembly 142. FIG. 9 is a perspective view of the second motor drive transmission assembly 142 as viewed from above.

The conveyance roller drive transmission assembly 142a includes first to third pulleys 143a to 143c, a belt 144, and first and second gears 145a to 145b. The separation roller drive transmission assembly 142b includes the first to third pulleys 143a to 143c, the belt 144, the second gear 145b, third to twelfth gears 145c to 145l, a shaft 146, a clutch 147, and a torque limiter 148. In other words, the conveyance roller drive transmission assembly 142a and the separation roller drive transmission assembly 142b share the first to third pulleys 143a to 143c, the belt 144, and the second gear 145b.

The first pulley 143a is mounted on the portion of the second rotation shaft 140b of the second motor 140 that protrudes outward. The belt 144 is stretched around the first pulley 143a, the second pulley 143b, and the third pulley 143c. The second pulley 143b is mounted on the first ejection shaft 117a on which the first ejection roller 117 is mounted. The third pulley 143c is mounted on the first conveyance shaft 114a on which the first conveyance roller 114 is mounted. The gear portion of the second pulley 143b is engaged with the first gear 145a. The first gear 145a is mounted on the second ejection shaft 118a on which the second ejection roller 118 is mounted. The gear portion of the third pulley 143c is engaged with the second gear 145b. The second gear 145b is mounted on the second conveyance shaft 115a on which the second conveyance roller 115 is mounted.

The second gear 145b is engaged with the third gear 145c. The third gear 145c is engaged with the fourth gear 145d. The fourth gear 145d is engaged with the fifth gear 145c. The fifth gear 145e is engaged with the sixth gear 145f. The sixth gear 145f is engaged with the seventh gear 145g. The seventh gear 145g is engaged with the eighth gear 145h. The eighth gear 145h is engaged with the ninth gear 145i. The ninth gear 145i is mounted on the shaft 146. Further, the tenth gear 145j is mounted on the shaft 146. The tenth gear 145j is engaged with the eleventh gear 145k. The eleventh gear 145k is engaged with the twelfth gear 145l. The twelfth gear 145l is mounted on the separation shaft 113a on which the separation roller 113 is mounted.

The clutch 147 is located on the eighth gear 145h. The clutch 147 is a mechanical clutch. The clutch 147 may be an electromagnetic clutch. The clutch 147 selectively transmits or interrupts the second driving force from the second motor 140 to the separation roller 113 according to either a change in the rotation direction of the clutch 147 or a control signal from the processing circuit.

The torque limiter 148 is mounted on the separation shaft 113a. The torque limiter 148 determines the limit of the torque applied to the separation roller 113. The limit of the torque limiter 148 is set to satisfy the following conditions. The rotational force via the torque limiter 148 is interrupted when there is one medium, and the rotational force via the torque limiter 148 is transmitted when there are two or more media. As a result, when only one medium is conveyed, the separation roller 113 rotates following the feed roller 112 without receiving the driving force from the second motor 140. When two or more media are conveyed, the separation roller 113 rotates in the direction A5 opposite to the medium feeding direction and separates the medium in contact with the feed roller 112 from other media, to prevent the occurrence of multi-feed. At this time, instead of rotating in the direction A5 opposite to the medium feeding direction, the separation roller 113 may be kept stationary such that the outer circumferential surface of the separation roller 113 applies force to the media in the direction A5 opposite to the medium feeding direction.

The operations of the separation roller 113, the first conveyance roller 114, the second conveyance roller 115, the first ejection roller 117, and the second ejection roller 118 are described below.

When the second motor 140 generates the second driving force in the rotational direction indicated by arrow C1, the first pulley 143a rotates in the direction indicated by arrow C1, which rotates the second and third pulleys 143b and 143c in the directions indicated by arrows C2 and C3, respectively. Accordingly, the first and second gears 145a and 145b rotate in the directions indicated by arrows C4 and C5, respectively. Accordingly, the first conveyance roller 114, the second conveyance roller 115, the first ejection roller 117, and the second ejection roller 118 are rotated by the second driving force from the second motor 140 in the medium conveying directions A6 to A9 together with the first conveyance shaft 114a, the second conveyance shaft 115a, the first ejection shaft 117a, and the second ejection shaft 118a, respectively, to convey the medium. In this manner, the conveyance roller drive transmission assembly 142a transmits the second driving force for rotating the first conveyance roller 114, the second conveyance roller 115, the first ejection roller 117, and the second ejection roller 118 from the second motor 140 to the first conveyance shaft 114a, the second conveyance shaft 115a, the first ejection shaft 117a, and the second ejection shaft 118a.

When the second gear 145b rotates in the direction indicated by arrow C5, the third to twelfth gears 145c to 145l rotate in the directions indicated by arrows C6 to C15, respectively. As a result, the separation roller 113 is rotated in the direction A5 opposite to the medium feeding direction by the second driving force from the second motor 140 together with the separation shaft 113a, to separate the medium. In this manner, the separation roller drive transmission assembly 142b transmits the second driving force for rotating the separation roller 113 from the second motor 140 to the separation shaft 113a. When the clutch 147 is set to interrupt the transmission of the driving force from the second motor 140, the second driving force is not transmitted to the separation roller 113, and the separation roller 113 rotates following the feed roller 112 in the medium feeding direction opposite to the direction indicated by arrow A5.

By contrast, when the second motor 140 generates the second driving force in the rotational direction opposite to the direction indicated by arrow C1, the first to third pulleys 143a to 143c and the first to twelfth gears 145a to 145l rotate in the directions indicated by arrows C1 to C15, respectively. With this rotation, the first conveyance roller 114, the second conveyance roller 115, the first ejection roller 117, and the second ejection roller 118 are rotated by the second driving force in the directions opposite to the medium conveying directions A6 to A9, respectively. The separation roller 113 is rotated by the second driving force in the medium feeding direction opposite to the direction indicated by arrow A5.

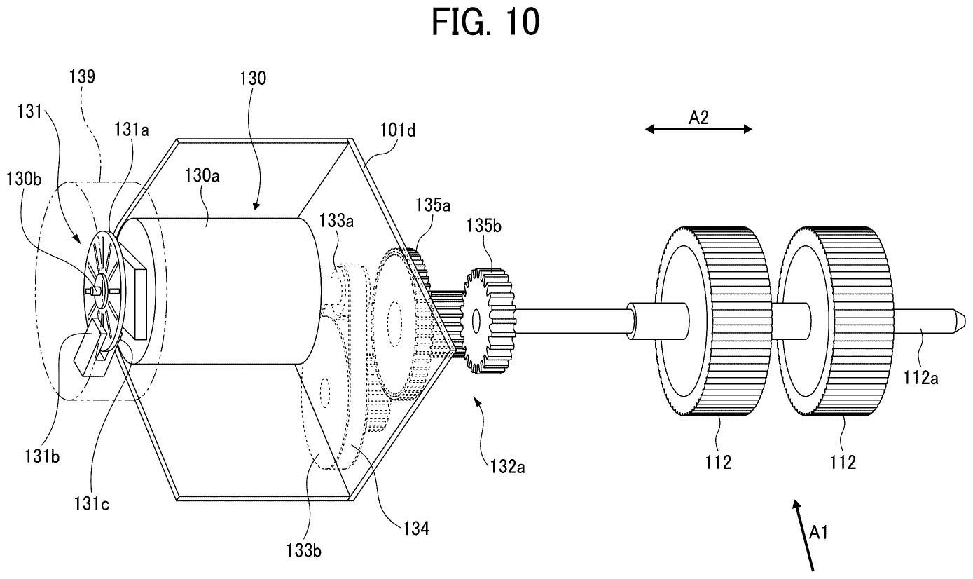

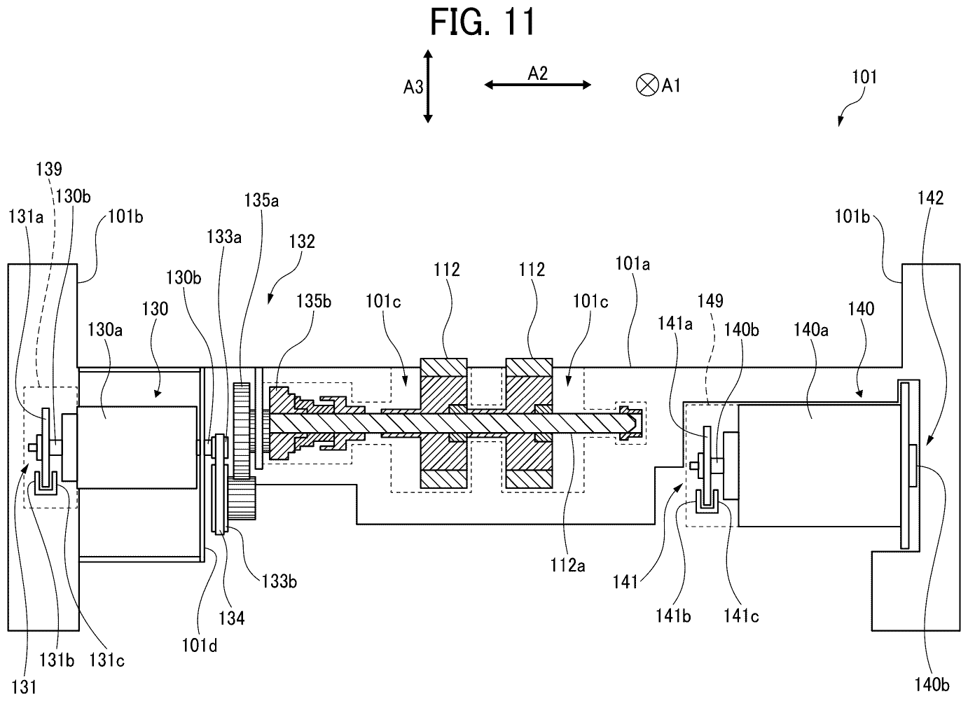

FIGS. 10 and 11 are schematic diagrams for explaining the first sensor 131 and the second sensor 141. FIG. 10 is a perspective view of the feed roller 112, the first motor 130, the drive transmission mechanism for the feed roller 112, the first sensor 131, etc., as viewed from upstream. FIG. 11 is a schematic view of the lower housing 101 including the feed roller 112, the first motor 130, the drive transmission mechanism for the feed roller 112, the first sensor 131, the second motor 140, and the second sensor 141, as viewed from upstream.

For example, the first sensor 131 is an encoder. The first sensor 131 includes a disk 131a, a light emitter 131b, and a light receiver 131c. The disk 131a is a scale and is located on the first rotation shaft 130b of the first motor 130 to rotate following the rotation of the first motor 130. The disk 131a has multiple slits (light transmission holes). The light emitter 131b and the light receiver 131c face each other across the disk 131a. The light emitter 131b is, for example, a light-emitting diode (LED) and emits light toward the disk 131a. The light receiver 131c is, for example, a photodiode and receives the light emitted from the light emitter 131b through the disk 131a. The light receiver 131c detects the number of changes per unit time from a state where the slits are present between the light emitter 131b and the light receiver 131c to a state where the slits are not present therebetween, but the disk 131a blocks the light. The light receiver 131c detects the value obtained by dividing the detected number of changes by the number of slits in the disk 131a as the number of rotations per unit time of the first motor 130. Then, the light receiver 131c generates and outputs a first detection signal indicating the detected number of rotations. The number of rotations per unit time of the first motor 130 is an example of the amount of rotation of the first motor 130. Alternatively, the first sensor 131 may detect, for example, the rotation speed or the rotation cycle of the first motor 130 as the rotation amount.

As illustrated in FIG. 11, the feed roller 112 is located in the recessed portion 101c formed in the lower guide 101a. The end of the feed shaft 112a on the opposite side to the first motor 130, that is, the end closer to the second motor 140 is rotatably supported by a wall portion of the recessed portion 101c. The wall portion of the recessed portion 101c is closed. On the side closer to the second motor 140 in the recessed portion 101c, no clearance is present for paper dust, which adheres to the medium fed by the feed roller 112 and falls into the recessed portion 101c from the medium, to reach the second motor 140. By contrast, the end of the feed shaft 112a closer to the first motor 130 is connected to the first motor 130 via the feed roller drive transmission assembly 132a. Accordingly, on the side closer to the first motor 130 in the recessed portion 101c, a clearance communicating with the first motor 130 is present for passing the feed roller drive transmission assembly 132a via the recessed portion 101c. This clearance may allow the paper dust to reach the first motor 130.

In the width direction A2, the feed roller drive transmission assembly 132a is located closer to the feed roller 112 than the first body 130a of the first motor 130, and the first sensor 131 is located on the side opposite the feed roller 112 with respect to the first body 130a of the first motor 130. This arrangement prevents the paper dust from reaching the first sensor 131 even when the paper dust passes from the recessed portion 101c through the clearance for passing the feed roller drive transmission assembly 132a. Accordingly, the paper dust adhering to the fed medium is prevented from adhering to the slits of the disk 131a, the light emitter 131b, or the light receiver 131c. The medium feeding apparatus 100 can enhance the dustproof property of the first sensor 131 and can prevent decreases in the detection accuracy of the number of rotations of the first motor 130. Accordingly, the medium feeding apparatus 100 can feed a medium and appropriately image the medium while appropriately separating the medium.

The lower housing 101 further includes a wall portion 101d located between the recessed portion 101c and the first motor 130. The first motor 130 is attached to the wall portion 101d. The paper dust adhering to the fed medium is further prevented from reaching the first motor 130 by the wall portion 101d located between the recessed portion 101c and the first motor 130.

The medium feeding apparatus 100 further includes a first cover 139. The first cover 139 is an example of a cover. The first cover 139 is a lid, such as a cap, and is located to cover the first sensor 131 to protect the first sensor 131 from dirt, such as paper dust or dust entering from outside the medium feeding apparatus 100. Covering the first sensor 131 with the first cover 139 can prevent dirt (e.g., paper dust adhering to the fed medium or dust from outside) from adhering to the slits in the disk 131a, the light emitter 131b, or the light receiver 131c.

In particular, the first cover 139 is attached to the first motor 130 to cover the first sensor 131. This structure reliably prevents the dirt (e.g., paper dust adhering to the fed medium or dust from outside the medium feeding apparatus 100) from reaching the first sensor 131.

The second sensor 141 is, for example, an encoder. The second sensor 141 includes a disk 141a, a light emitter 141b, and a light receiver 141c. The disk 141a is a scale and is located on the second rotation shaft 140b of the second motor 140 to rotate following the rotation of the second motor 140. The disk 141a has multiple slits (light transmission holes). The light emitter 141b and the light receiver 141c face each other across the disk 141a. The light emitter 141b is, for example, an LED and emits light toward the disk 141a. The light receiver 141c is, for example, a photodiode and receives the light emitted from the light emitter 141b through the disk 141a. The light receiver 141c detects the number of changes per unit time from a state where the slits are present between the light emitter 141b and the light receiver 141c to a state where the slits are not present therebetween, but the disk 141a blocks the light. The light receiver 141c detects the value obtained by dividing the detected number of changes by the number of slits in the disk 141a as the number of rotations per unit time of the second motor 140. Then, the light receiver 141c generates and outputs a second detection signal indicating the detected number of rotations. The number of rotations per unit time of the second motor 140 is an example of the amount of rotation of the second motor 140. Alternatively, the second sensor 141 may detect, for example, the rotation speed or the rotation cycle of the second motor 140 as the rotation amount.

In the width direction A2, the second motor drive transmission assembly 142 is located on the side opposite the feed roller 112 with respect to the second body 140a of the second motor 140, and the second sensor 141 is located closer to the feed roller 112 than the second body 140a of the second motor 140. As described above, on the side closer to the second motor 140 in the recessed portion 101c, no clearance is present for paper dust, which adheres to the medium fed by the feed roller 112 and falls into the recessed portion 101c from the medium, to reach the second motor 140. Accordingly, even if the second sensor 141 is located closer to the feed roller 112, the paper dust does not reach the second sensor 141. Thus, the medium feeding apparatus 100 can enhance the dustproof property of the second sensor 141 and prevent decreases in the detection accuracy of the number of rotations of the second motor 140. Accordingly, the medium feeding apparatus 100 can feed a medium and appropriately image the medium while appropriately separating the medium.

By contrast, the second motor drive transmission assembly 142 is located on the outer side in the width direction A2 and easily transmits the second driving force from the lower housing 101 to the upper housing 102 through the area outside the medium conveying path. As a result, the medium feeding apparatus 100 can drive the first conveyance roller 114, the second conveyance roller 115, the first ejection roller 117, and the second ejection roller 118 by a single motor, i.e., the second motor 140.

The medium feeding apparatus 100 further includes a second cover 149. The second cover 149 is a lid, such as a cap, and is located to cover the second sensor 141 to protect the second sensor 141 from dirt, such as paper dust or dust entering from outside the medium feeding apparatus 100. Covering the second sensor 141 with the second cover 149 can prevent dirt, such as dust from outside the medium feeding apparatus 100, from adhering to the slits in the disk 141a, the light emitter 141b, or the light receiver 141c.

In particular, the second cover 149 is attached to the second motor 140 to cover the second sensor 141. This structure reliably prevents the dirt, such as dust from outside the medium feeding apparatus 100, from reaching the second sensor 141.

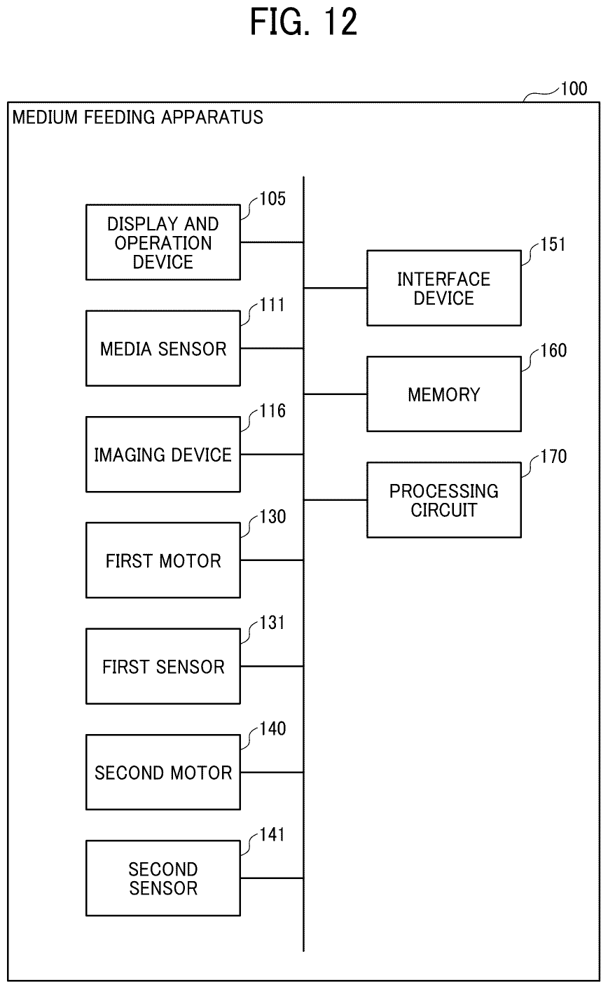

FIG. 12 is a block diagram illustrating a schematic configuration of the medium feeding apparatus 100.

The medium feeding apparatus 100 further includes an interface device 151, a memory 160, and a processing circuit 170 in addition to the configuration described above.

The interface device 151 includes an interface circuit compatible with a serial bus such as a universal serial bus (USB) and is electrically connected to an information processing apparatus (e.g., a personal computer or a mobile information processing terminal) to transmit and receive input images and various kinds of information to and from the information processing apparatus. The interface device 151 may be substituted by a communication device that includes an antenna to transmit and receive wireless signals and a wireless communication interface device to transmit and receive signals through a wireless communication line according to a given communication protocol. The given communication protocol is, for example, a wireless local area network (LAN) communication protocol. The communication device may include a wired communication interface device to transmit and receive signals through a wired communication line according to a communication protocol such as a wired LAN communication protocol.

The memory 160 includes memories such as a random-access memory (RAM) and a read-only memory (ROM), a fixed disk device such as a hard disk, or a portable memory such as a flexible disk or an optical disk. The memory 160 stores, for example, computer programs, databases, and tables used for various processes performed by the medium feeding apparatus 100. The computer programs may be installed in the memory 160 from a computer-readable portable recording medium using, for example, a setup program. Examples of the portable recording medium include a compact disc-read-only memory (CD-ROM) and a digital versatile disc read-only memory (DVD-ROM). The computer programs may be distributed from, for example, a server and installed in the memory 160.

The processing circuit 170 operates according to a program prestored in the memory 160. The processing circuit is, for example, a central processing unit (CPU). Alternatively, a digital signal processor (DSP), a large-scale integration (LSI), an application-specific integrated circuit (ASIC), a field-programmable gate array (FPGA), etc., may be used as the processing circuit 170.

The processing circuit 170 is connected to the display and operation device 105, the media sensor 111, the imaging device 116, the first motor 130, the first sensor 131, the second motor 140, the second sensor 141, the interface device 151, the memory 160, etc., and controls these devices. The processing circuit 170 controls the driving of the first motor 130 and the second motor 140, the imaging by the imaging device 116, etc., according to the media signal received from the media sensor 111, the first detection signal received from the first sensor 131, and the second detection signal received from the second sensor 141. The processing circuit 170 obtains an input image from the imaging device 116 and transmits the input image to the information processing apparatus via the interface device 151.

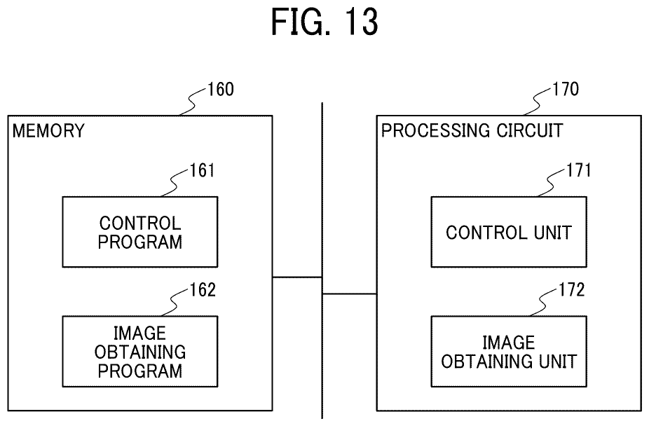

FIG. 13 is a block diagram illustrating schematic configurations of the memory 160 and the processing circuit 170.

As illustrated in FIG. 13, the memory 160 stores a control program 161 and an image obtaining program 162. These programs are functional modules implemented by software that operates on the processor. The processing circuit 170 reads the programs from the memory 160 and operates according to the read programs. Thus, the processing circuit 170 functions as a control unit 171 and an image obtaining unit 172.

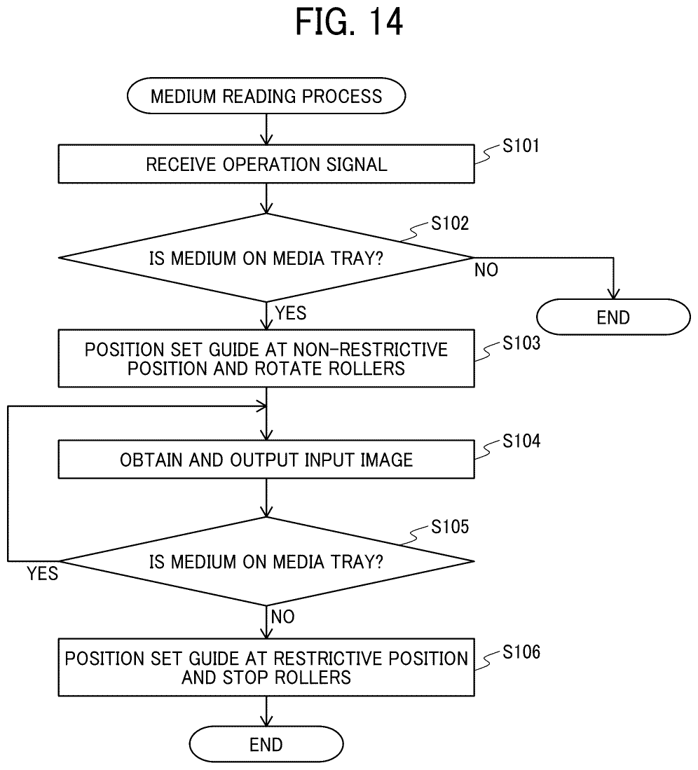

FIG. 14 is a flowchart of a medium reading process of the medium feeding apparatus 100.

The medium reading process performed by the medium feeding apparatus 100 is described below with reference to the flowchart of FIG. 14. The process described below is executed, for example, by the processing circuit 170 in cooperation with the components of the medium feeding apparatus 100 according to the programs prestored in the memory 160.

When the medium feeding apparatus 100 is activated, the control unit 171 controls the first motor 130 to position the set guide 121 at the restrictive position. Accordingly, the set guide 121 is positioned at the restrictive position before the medium reading process is performed.

In step S101, the control unit 171 stands by until an operation signal instructing the reading of a medium is received from the display and operation device 105 or an information processing apparatus via the interface device 151. The operation signal is output when a user inputs an instruction to read the medium using the display and operation device 105 or the information processing apparatus. The operation signal includes the operation mode (separation mode/non-separation mode) of the medium feeding apparatus 100 designated in addition to the reading instruction instructed by the user using the display and operation device 105 or an information processing apparatus. The operation mode may not be included in the operation signal and may be set before the medium reading process is executed.

In step S102, the control unit 171 obtains a media signal from the media sensor 111 and determines whether a medium is placed on the media tray 103 based on the obtained media signal. The control unit 171 ends the series of steps when no medium is placed on the media tray 103.

By contrast, when a medium is on the media tray 103 (Yes in step S102), the control unit 171 controls the first motor 130 and the second motor 140 to start feeding and conveying the medium in step S103. The control unit 171 controls the first motor 130 to rotate in the direction indicated by arrow B1 in FIGS. 7 and 8 to move the set guide 121 from the restrictive position to the non-restrictive position and rotate the feed roller 112 in the medium feeding direction A4.

When the operation mode is set to the separation mode, the control unit 171 rotates the second motor 140 in the direction indicated by arrow C1 in FIG. 9. Accordingly, the control unit 171 rotates the separation roller 113 in the direction A5 opposite to the medium feeding direction and rotates the first conveyance roller 114, the second conveyance roller 115, the first ejection roller 117, and the second ejection roller 118 in the medium conveying directions A6 to A9, respectively.

By contrast, when the operation mode is set to the non-separation mode, the control unit 171 rotates the second motor 140 in the direction opposite to the direction indicated by arrow C1 in FIG. 9 for a predetermined time at the start of feeding of each medium, thereby rotating the separation roller 113 in the medium feeding direction. The predetermined time is set, for example, to the time from when the feeding of the medium is started to when the leading end of the medium passes through the nip between the feed roller 112 and the separation roller 113. At this time, the first conveyance roller 114, the second conveyance roller 115, the first ejection roller 117, and the second ejection roller 118 rotate in the directions opposite to the medium conveying directions A6 to A9, respectively. However, no problem occurs because the leading end of the medium does not reach the positions of the first conveyance roller 114, the second conveyance roller 115, the first ejection roller 117, and the second ejection roller 118 at that time. After that, the control unit 171 interrupts the transmission of the second driving force from the second motor 140 to the separation roller 113. As a result, the separation roller 113 rotates following the feed roller 112. Further, the control unit 171 rotates the second motor 140 in the direction indicated by arrow C1 in FIG. 9 to rotate the first conveyance roller 114, the second conveyance roller 115, the first ejection roller 117, and the second ejection roller 118 in the medium conveying directions A6 to A9, respectively.

When the operation mode is set to the non-separation mode, the control unit 171 may set the second driving force from the second motor 140 not to be transmitted to the separation roller 113 at the start of feeding of each medium. In this case, at the start of feeding of each medium, the control unit 171 rotates the second motor 140 in the direction indicated by arrow C1 in FIG. 9 to rotate the first conveyance roller 114, the second conveyance roller 115, the first ejection roller 117, and the second ejection roller 118 in the medium conveying directions A6 to A9, respectively.

After that, the control unit 171 periodically receives the first detection signal from the first sensor 131 and controls the first motor 130 to rotate at a predetermined speed based on the first detection signal. After that, the control unit 171 periodically receives the second detection signal from the second sensor 141 and controls the second motor 140 to rotate at a predetermined speed based on the second detection signal.

In step S104, the image obtaining unit 172 controls the imaging device 116 to image the medium, obtains an input image from the imaging device 116, and transmits the input image to the information processing apparatus via the interface device 151 to output the input image.

In step S105, the control unit 171 determines whether a medium remains on the media tray 103 based on the media signal received from the media sensor 111. When a medium remains on the media tray 103, the control unit 171 returns the process to step S104 and repeats the process from step S104 to S105.

In contrast, when no medium remains on the media tray 103 (No in step S105), in step S106, the control unit 171 controls the first motor 130 and the second motor 140 to stop feeding and conveying a medium, and ends the series of steps. The control unit 171 controls the first motor 130 to rotate in the direction opposite to the direction indicated by arrow B1 in FIGS. 7 and 8 for a certain period of time to move the set guide 121 from the non-restrictive position to the restrictive position. Then, the control unit 171 stops the first motor 130 to stop the feed roller 112. As described above, even when the supply of power to the first motor 130 is stopped with the set guide 121 positioned at the restrictive position, the set guide 121 is kept at the restrictive position. The control unit 171 stops the second motor 140 to stop the separation roller 113, the first conveyance roller 114, the second conveyance roller 115, the first ejection roller 117, and/or the second ejection roller 118.

As described above in detail, in the medium feeding apparatus 100, the feed roller drive transmission assembly 132a to transmit the first driving force from the first motor 130 to the feed shaft 112a of the feed roller 112 is located inner than the end of the medium conveying path in the width direction A2. This arrangement can reduce the size of the medium feeding apparatus 100 in the width direction A2, thereby reducing the apparatus size.

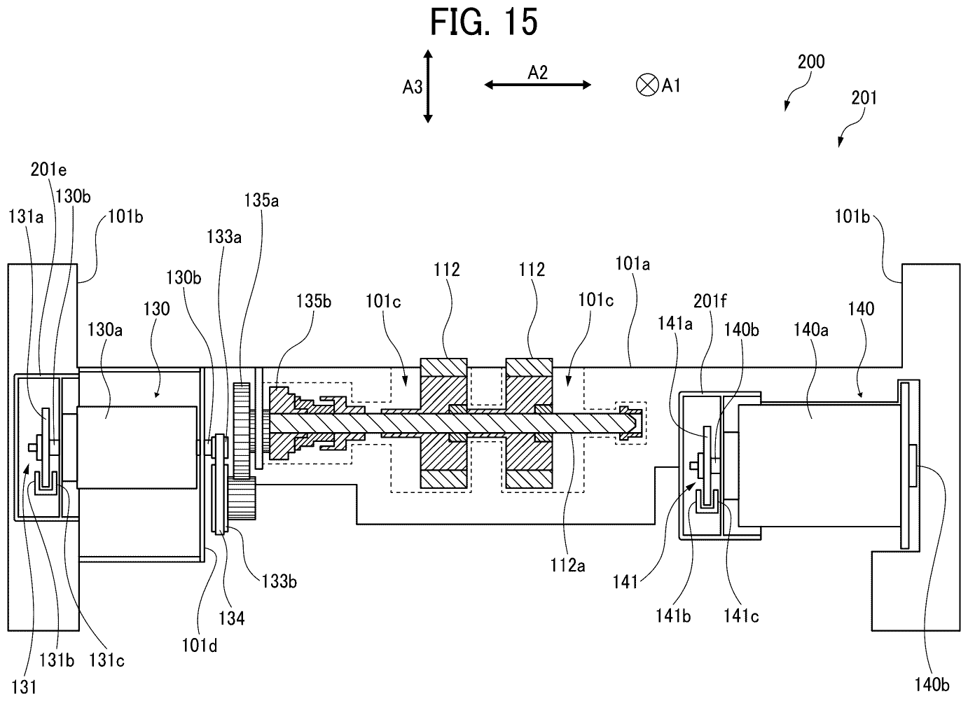

FIG. 15 is a schematic diagram for explaining a first sensor and a second sensor of a medium feeding apparatus 200 according to another embodiment. FIG. 15 is a schematic view of a lower housing 201 including the feed roller 112, the first motor 130, the drive transmission mechanism for the feed roller 112, the first sensor 131, the second motor 140, and the second sensor 141, as viewed from upstream.

The medium feeding apparatus 200 is similar in configuration and function to the medium feeding apparatus 100. However, the medium feeding apparatus 200 includes the lower housing 201 instead of the lower housing 101, and includes a first cover 201e and/or a second cover 201f instead of the first cover 139 and/or the second cover 149. The lower housing 201 is similar in configuration and function to the lower housing 101. However, the first cover 201e and/or the second cover 201f are formed in the lower housing 201.

The first cover 201e is an example of the cover. The first cover 201e is a wall portion of the lower housing 201. The first cover 201e is located to cover the first sensor 131 and protects the first sensor 131 from dirt, such as paper dust or dust. Covering the first sensor 131 with the first cover 201e can prevent dirt, such as paper dust or dust, from adhering to the slits in the disk 131a, the light emitter 131b, or the light receiver 131c.

The first cover 201e is integral with the lower housing 201 of the medium feeding apparatus 200. This eliminates the need for a component dedicated to covering the first sensor 131, and the medium feeding apparatus 200 can prevent dirt, such as paper dust or dust, from reaching the first sensor 131 while preventing an increase in the apparatus cost.

The second cover 201f is a wall portion of the lower housing 201. The second cover 201f is located to cover the second sensor 141 and protects the second sensor 141 from dirt, such as paper dust or dust. Covering the second sensor 141 with the second cover 201f can prevent dirt, such as paper dust or dust, from adhering to the slits in the disk 141a, the light emitter 141b, or the light receiver 141c.

The second cover 201f is integral with the lower housing 201 of the medium feeding apparatus 200. This eliminates the need for a component dedicated to covering the second sensor 141, and the medium feeding apparatus 200 can prevent dirt, such as dust, from reaching the second sensor 141 while preventing an increase in the apparatus cost.

As described above in detail, the medium feeding apparatus 200 can reduce the apparatus size even when the first sensor 131 and/or the second sensor 141 are covered by the first cover 201e and/or the second cover 201f.

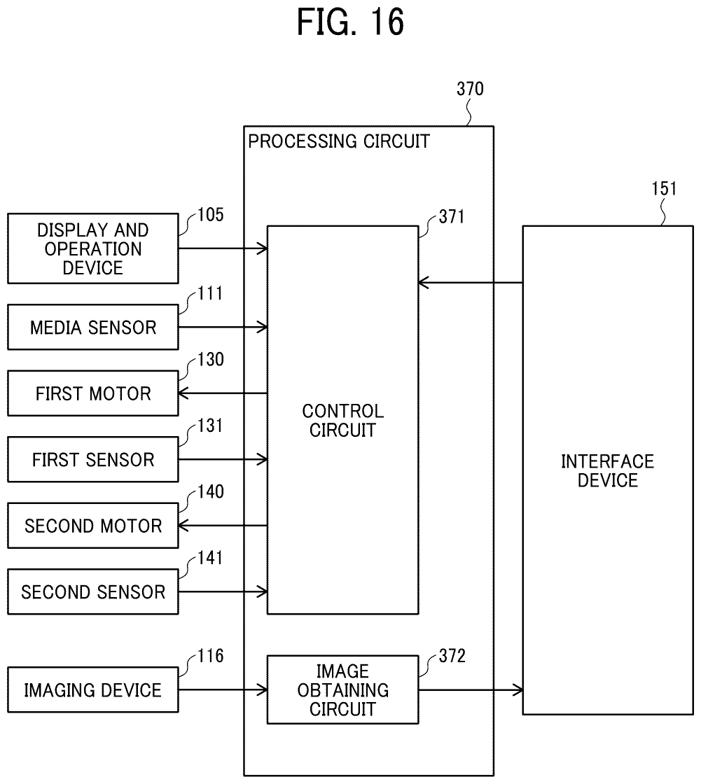

FIG. 16 is a block diagram illustrating a schematic configuration of a processing circuit 370 of another medium feeding apparatus.

The processing circuit 370 is used in place of the processing circuit 170 and performs the medium reading process, etc., in place of the processing circuit 170. The processing circuit 370 includes a control circuit 371 and an image obtaining circuit 372. These circuits may be implemented by independent integrated circuits, microprocessors, firmware, or a combination thereof.

The control circuit 371 is an example of control circuitry and functions like the control unit 171. The control circuit 371 receives the operation signal from the display and operation device 105 or the information processing apparatus via the interface device 151, the media signal from the media sensor 111, the first detection signal from the first sensor 131, and the second detection signal from the second sensor 141. The control circuit 371 controls the first motor 130 and the second motor 140 based on the received signals.

The image obtaining circuit 372 is an example of the image obtaining unit and functions like the image obtaining unit 172. The image obtaining circuit 372 obtains an input image from the imaging device 116 and outputs the input image to the interface device 151.

The medium feeding apparatus can reduce the apparatus size as described above in detail, also when the processing circuit 370 is used.

Embodiments of the present disclosure are not limited to the above-described embodiments. For example, the medium conveying path may be a so-called U-turn path, and the medium feeding apparatus may feed and convey media placed on the media tray sequentially from the top and eject the media to the ejection tray. In this configuration, the separation roller is located below the feed roller to face the feed roller.

The medium feeding apparatus may include an image forming device instead of or in addition to the imaging device 116. The image forming device employs, for example, an inkjet printing method or a laser printing method, is located at the position corresponding to the position of the imaging device 116, and forms an image (prints information) on a medium conveyed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A medium feeding apparatus comprising:
a media tray;
a feed roller to feed a medium placed on the media tray;
a driving source to generate a driving force; and
a drive transmission assembly to transmit the driving force from the driving source to a rotation shaft of the feed roller,
wherein the drive transmission assembly is located inner than an end of a medium conveying path in a direction intersecting a medium conveying direction.

2. The medium feeding apparatus according to claim 1, further comprising:
a second driving source located on an opposite side of the driving source with respect to a center position of the medium conveying path in the direction intersecting the medium conveying direction, wherein the second driving source generates a second driving force;
a conveyance roller located downstream from the feed roller in the medium conveying direction; and
a second drive transmission assembly to transmit the second driving force to a rotation shaft of the conveyance roller.

3. The medium feeding apparatus according to claim 2, further comprising:
a separation roller facing the feed roller; and
a third drive transmission assembly to transmit the second driving force to a rotation shaft of the separation roller,
wherein the third drive transmission assembly is located on a same side as the second drive transmission assembly with respect to the center position of the medium conveying path in the direction intersecting the medium conveying direction.

4. The medium feeding apparatus according to claim 1, further comprising a sensor located on a rotation shaft of the driving source, wherein
the driving source is a direct current motor,
the sensor detects a rotation amount of the driving source,
the drive transmission assembly is closer to the feed roller than a body of the driving source in the direction intersecting the medium conveying direction, and
the sensor is located on an opposite side of the feed roller with respect to the body of the driving source in the direction intersecting the medium conveying direction.

5. The medium feeding apparatus according to claim 4, further comprising
a cover covering the sensor.

6. The medium feeding apparatus according to claim 5,
wherein the cover includes a lid attached to the driving source.

7. The medium feeding apparatus according to claim 5,
wherein the cover is integral with a housing of the medium feeding apparatus.
